(19) United States
(12) Patent Application Publication
(10) Pub. No.: US 2007/0203727 A1
(43) Pub. Date: Aug. 30, 2007

(54) EMERGENCY SUPPLIES PRE-POSITIONING AND ACCESS CONTROL METHOD

(76) Inventor: Barrett H. MOORE, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/456,472

(22) Filed: Jul. 10, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/361,247, filed on Feb. 24, 2006.
Application No. 11/361,247 is a continuation-in-part of application No. 11/381,265, filed on May 2, 2006.
Application No. 11/381,265 is a continuation-in-part of application No. 11/421,694, filed on Jun. 1, 2006.

(51) Int. Cl. G06Q 10/00

(52) U.S. Cl. 705/1

(57) ABSTRACT

One provides (101) a plurality of carriable containers having emergency supplies contained therein wherein each of these carriable containers is readily carriable by an average adult human. These carriable containers are then placed (103) within one or more corresponding controlled access containers as are provided at one or more publicly accessible locations (102). Prior to a triggering catastrophic event, one or more specific authorized beneficiaries are then preauthorized (104) to have catastrophic event-based access to one or more of these carriable containers. So configured, the authorized beneficiary(s) will in turn have access to the corresponding emergency supplies that are contained within the carriable container when a triggering catastrophic event occurs.

### RELATED APPLICATIONS

This comprises a continuation-in-part of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265; and

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043; and

PRIVATE CIVIL DEFENSE-THEMED TELEVISION BROADCASTING METHOD as filed on Jun. 23, 2006 and having application Ser. No. 11/426,231; the contents of which are fully incorporated herein by this reference.

### TECHNICAL FIELD

This invention relates generally to facilitating the availability of emergency supplies.

### BACKGROUND

As powerful as the machinery of modern life appears, modern citizens are today perhaps more at risk of experiencing a serious disruption in their ability to prosper or even to survive en mass than is generally perceived. A serious disruption to any significant element of civilized infrastructure can produce catastrophic results for a broad swatch of a given civil community. Any number of natural and/or intentionally-caused events can significantly disrupt society's infrastructure and present a variety of differing threats and problems to the individual.

Many people believe and trust that their government (local, regional, and/or national) will provide for them in the event of such catastrophic occurences. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a large-scale catastrophic event occurs. One may also observe that most communities simply cannot afford to staff and support a contingent capability to deal with a wide variety of likely infrequent and possibly unpredictable extreme events.

When a civilly-catastrophic event occurs, substantially sudden civil upheaval will often follow. Not only will society's infrastructure be rendered, but people in general are known to act in ways that are different and sometimes unexpected when faced with circumstances that threaten their well being or survival. This, coupled with the characterizing effects of the civilly-catastrophic event itself, can present an affected person with numerous challenges. These challenges can be particularly troubling for persons located in crowded urban settings. On the one hand, modern governments typically do little to proactively ensure the ability to quickly and safely effect care of their citizens in the face of many civilly-catastrophic events. As a result, for example, persons who are caught working at a downtown office when a civilly-catastrophic event occurs may well find themselves having to fend for themselves at least for some period of time with respect to protecting themselves.

On the other hand, attempting to take responsible actions to reasonably ensure one's own abilities in this regard can become, in and of itself, a seemingly insurmountable challenge. For example, a given individual may lack the means, expertise, skills, or ability to effectively pre-provision themselves with useful emergency supplies prior to the occurrence of a civilly-catastrophic event. Furthermore, even when a given individual is able to prepare an appropriate store in this regard, typical prior art practice will tend to prompt such persons to keep those supplies in, for example, a backpack that they retain at their office. When a civilly-catastrophic event occurs, however, time can be of the essence. Such a backpack may do the individual little good if that person is away from their office during the ordinary course of their day (with the problem only growing worse as the distance between the individual and that backpack increases for whatever reason).

For these and other reasons most if not all persons in a dense urban setting are typically bereft of a suitable store of portable emergency supplies that can be readily and quickly called upon in a time of need.

### BRIEF DESCRIPTION OF THE DRAWINGS

The above needs are at least partially met through provision of the emergency supplies pre-positioning and access control method described in the following detailed description, particularly when studied in conjunction with the drawings, wherein:

FIG. 1 comprises a flow diagram as configured in accordance with various embodiments of the invention;

FIG. 2 comprises a perspective schematic view as configured in accordance with various embodiments of the invention;

FIG. 3 comprises a perspective schematic view as configured in accordance with various embodiments of the invention;

FIG. 4 comprises a plan view as configured in accordance with various embodiments of the invention;

FIG. 5 comprises a perspective schematic view as configured in accordance with various embodiments of the invention;

FIG. 6 comprises a perspective schematic view as configured in accordance with various embodiments of the invention; and

FIG. 7 comprises a block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a plurality of carriable containers having emergency supplies contained therein wherein each of these carriable containers is readily carriable by an average adult human. These carriable containers are then placed within one or more corresponding controlled access containers as are provided at one or more publicly accessible locations. Prior to a triggering catastrophic event, one or more specific authorized beneficiaries are then preauthorized to have catastrophic event-based access to one or more of these carriable containers. So configured, the authorized beneficiary(s) will in turn have access to the corresponding emergency supplies that are contained within the carriable container when a triggering catastrophic event occurs.

The specific nature of the carriable container as well as the constituency of the emergency supplies can vary with the needs and/or requirements as characterize a given application setting. As one example in this regard, the nature of the carriable container and/or the emergency supplies can vary over time with respect to a most likely presently anticipated catastrophic event threat. As another example in this regard it would be possible to provide different carriable containers and/or different emergency supplies at a single one of the controlled access containers to thereby provide the authorized beneficiary with a broader selection of choices to perhaps facilitate better meeting a particular emergency scenario.

The specific nature of the access controlled container can also vary with the application setting. By one approach these access controlled containers can be configured and arranged to conceal their function as a container of one or more of the carriable containers. To illustrate, such access controlled containers can be configured and arranged to appear to be an ordinary piece of free-standing or built-in furniture, a work of art, a wall, and so forth.

Limiting access to such supplies to the aforementioned authorized beneficiaries can be accomplished using any of a variety of techniques, alone or in combination with one another. By one approach, if desired, such access can be denied in the absence of a likely genuine need to access the emergency supplies in order to meet an emergency situation.

So configured, relevant and well-maintained emergency supplies can be relatively widely distributed throughout an urban setting. At a time of need, authorized beneficiaries can visit a nearby and convenient controlled access container and gain access to a corresponding carriable container. Being carriable, the authorized beneficiary can then move on in a manner that best meets their immediate needs and plans while also having a useful store of appropriate provisions. This, in turn, can assist with their survival, convenience, and/or comfort regardless of whether they then seek temporary or longer-term shelter, transportation, rescue, or the like.

Those skilled in the art will recognize and appreciate that these teachings provide the authorized beneficiary with genuinely useful supplies in a manner that well accommodates the mobile nature of many persons and the complicated infrastructure in which they function. These steps may also be facilitated without dependency upon governmental oversight, participation, or control.

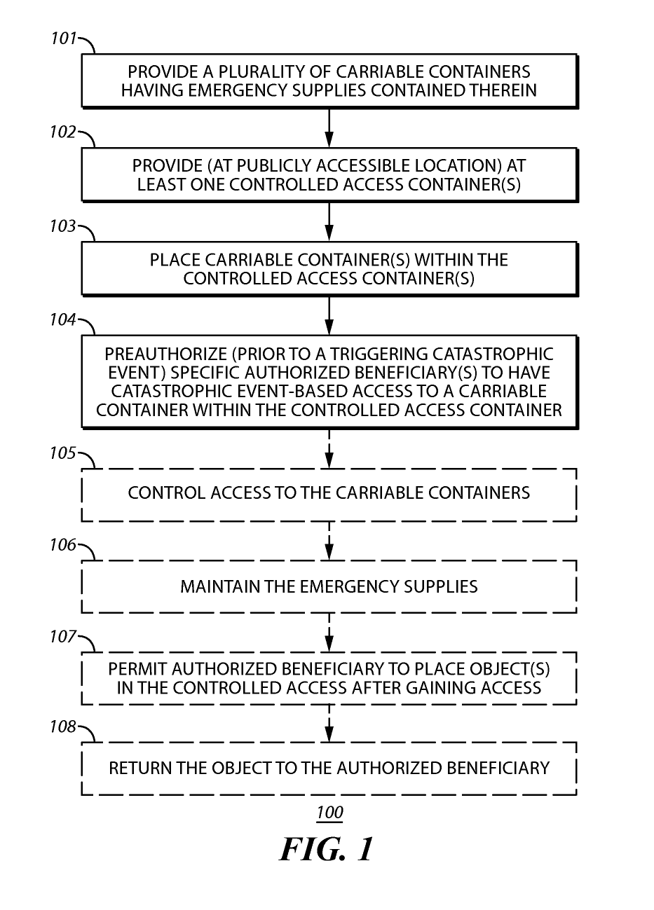

These and other benefits may become clearer upon making a thorough review and study of the following detailed description. Referring now to FIG. 1, an illustrative corresponding process 100 provides 101 a plurality of carriable containers having emergency supplies contained therein. By one approach, some or all of these carriable containers are each readily carriable by an average adult human and therefore weigh no more than, for example, about twenty pounds or so when fully provisioned. Other sizes may also be accommodated if desired, including smaller and/or larger packages. By one approach the carriable container can comprise a locked (or lockable) carriable container. This can comprise the use of built-in or add-on locks of various kinds as may be appropriate to a given application setting.

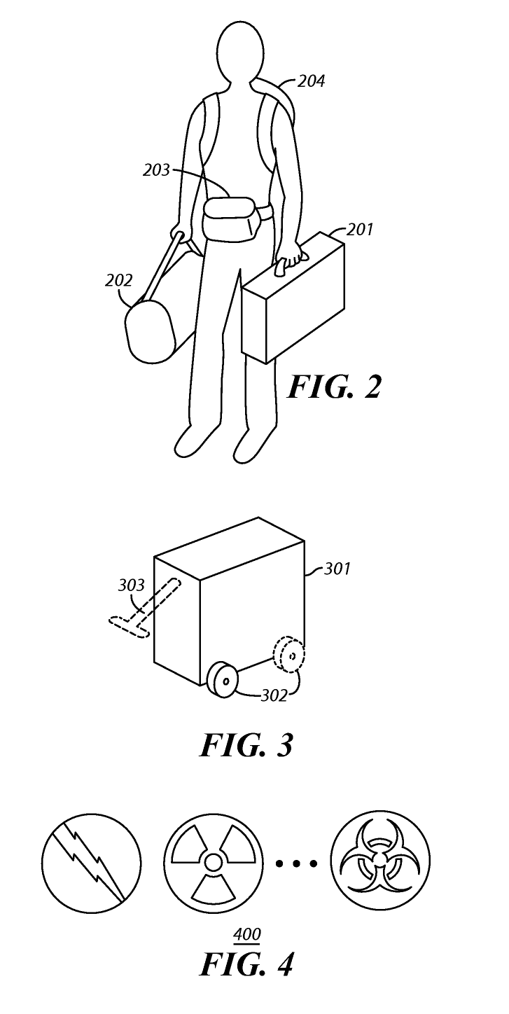

The carriable containers can assume any of a wide variety of form factors as desired. With momentary reference to FIG. 2, a few illustrative examples include a briefcase 201, a duffel bag 202, a so-called fanny pack 203, and a backpack 204. Other examples would include, but are not limited to, diaper bags, shopping bags, purses, shoulder bags, trash containers, physician's bags, suitcases, and so forth. With momentary reference to FIG. 3, although these carriable containers are, generally speaking, carriable, if desired the carriable container 301 can be configured and arranged to have one or more wheels 302 such that the carriable container 301 can be readily rolled on the wheels 302 to facilitate its movement. If desired, a handle 303 (fully or partially retractable or otherwise) can also be provided to facilitate such movement.

The emergency supplies themselves can and will vary with respect to the particular kind and/or category of anticipated emergency. Generally speaking, such emergency supplies may be directed towards items that aid with respect to at least one of providing immediate personal protection, providing longer-term personal protection, facilitating and/or meeting basic survival needs, providing and/or facilitating communications, navigation, and/or transport needs, facilitating threat assessment, and so forth.

Some specific illustrative examples in this regard could include, but are not limited to, nourishment (such as food, vitamins, and so forth), hydrating fluid (such as water, electrolytes, and so forth), foul weather clothing (such as waterproof clothing, insulated clothing, gloves, hats, hot weather and/or cold weather garb, and so forth), hazmat clothing (such as airtight clothing, ionizing radiation blocking clothing (as comprised, for example, of Demron fabric or the like), breathing filters (such as N95-rated face masks and the like), portable lighting (such as flashlights, chemical light rods, flares, and so forth), eye protection (such as clear, tinted, or polarized goggles or the like), medical supplies (such as first aid supplies or the like), potassium iodide, an ionizing radiation detector (such as a dosimeter), an ionizing radiation measurer (such as a Geiger counter), rope, a wearable harness (such as a rescue harness that can be readily coupled to a rescuer's rope or other retrieval gear), fire starter (such as matches, chemical lighters, spark creators, and so forth), one or more tools (such as shovels, levers, impact tools, multi-function tools, and so forth), weapons (including non-lethal weapons such as tazers, Asps or other club-like objects, disabling sprays, and so forth as well as lethal weapons), noisemakers (such as whistles, air horns, handheld clickers, and so forth), navigation equipment (such as compasses, global position satellite-based devices, maps, beacon-based devices, and so forth), communications equipment (including one-way and two-way wireless devices that accommodate voice and/or data), evacuation route information (including maps, printed instructions, and other forms of static and/or dynamic content-bearing platforms), flotation equipment (such as inflatable rafts (including but not limited to self-inflating rafts), inflatable life vests, and so forth), low-light vision equipment, lock-picking equipment (such as, but not limited to, tumbler pin and wafer picks, rakes and raking devices, and other lock mechanism engagement and manipulation members), shelter (such as a tent, lean-to material, or the like) and so forth.

Other supplies are also possible. As but one example in this regard, the emergency supplies may further comprise disguise supplies to permit an individual to significantly alter their appearance to thereby, for example, draw less third party interest to themselves. Such disguise supplies could comprise, but are not limited to, wigs, glasses, facial hair, skin coloration and/or texture materials, false teeth, and so forth.

As noted above, the emergency supplies can vary with respect to a particular kind or class of emergency to which the supplies are directed. By one approach, the carriable containers as provided 101 can vary from one another with respect to their emergency supplies to accommodate varying emergency scenarios. For example, some carriable containers can contain emergency supplies that are selected and appropriate for use with respect to a first emergency scenario (such as, for example, exposure to ionizing radiation) while other carriable containers contain emergency supplies that are selected and appropriate for use with respect to a second, different emergency scenario (such as, for example, an event that causes or threatens building structural integrity) that is different than the first emergency scenario.

In such a case, and referring momentarily to FIG. 4, it may be useful to have some or all of the carriable containers bear an externally visible indication 400 regarding a kind of emergency scenario for which the emergency supplies in that particular carriable container have been selected. Such visible indications can be icon based as suggested by the depiction provided in FIG. 4 and/or can be textually based as when descriptive words are provided to describe the relevant emergency situation to which the supplies are directed. It would also be possible to use color-based codes to convey the same information if desired.

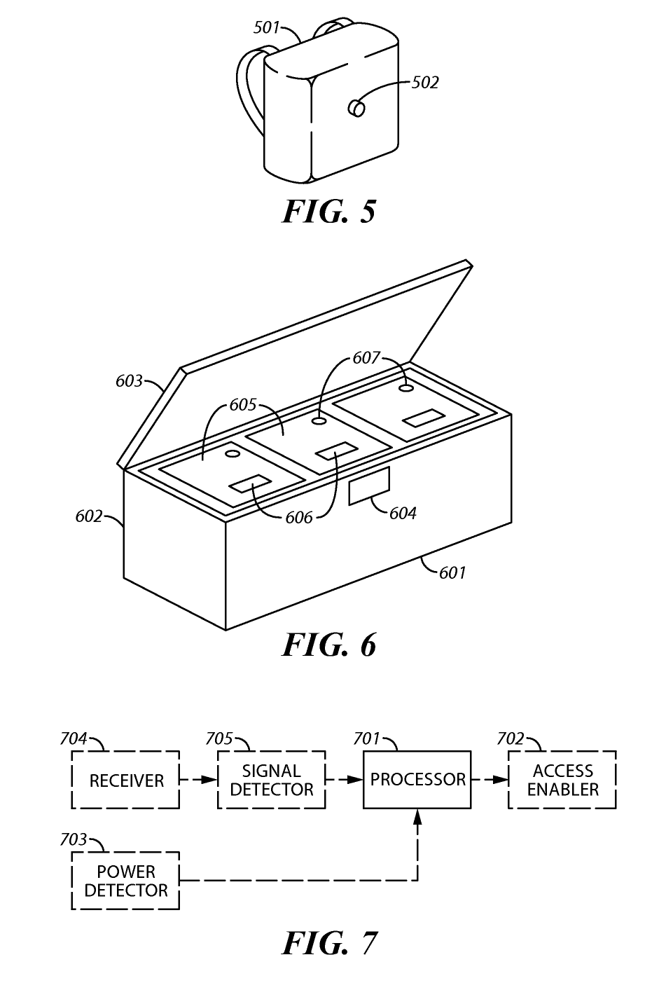

In some application settings, the carriable container may comprise a part of a larger overall survival strategy that includes, for example, rescue services. In such a case, and referring momentarily to FIG. 5, the carriable container 501 can further comprise external lighting 502. This external lighting 502 can comprise, for example, a constant illumination source and/or a strobing or otherwise fluctuating illumination source. Particular illumination colors may also be used, alone or in combination with particular flashing patterns, to facilitate ready identification and location of the individual by a rescue service. Such an approach may be particularly effective when applied in conjunction with a carriable container that is configured and arranged to attach to the individual.

Referring again to FIG. 1, this process 100 then provides 102, at at least one publicly accessible location, at least one controlled access container. A variety of publicly accessible locations are suitable for use in this regard. Some examples include, but are not limited to, building lobbies and nearby lobby-accessible rooms, entryways, dining areas and food courts, storefronts, public transportation stations (such as airports, train and bus stations, and so forth), hallways, and so forth. By one approach, a plurality of different publicly accessible locations are used (for example, a number of building lobbies for different buildings in a given urban setting).

The controlled access container itself can comprise any of a wide variety of form factors. As but one illustration in this regard, and referring momentarily to FIG. 6, a given controlled access container 601 can comprise a box-like section 602 having a hinged lid 603 that, when lowered, serves to fully enclose the space within the box-like section 602.

A locking mechanism 604 of choice can serve to retain the lid 603 in the closed position. This locking mechanism 604 can make use of any of a wide variety of presently available technologies such as physical key-based locks, enterable code-based locks (where a given code, such as a four digit number, is entered via a keypad, a speech recognition interface, or the like), and/or biometrics-based locks (that use, for example, fingerprints, voice recognition, retinal patterns, and so forth). As the present teachings are not particularly sensitive to the selection of any particular technology in this regard, for the sake of brevity further elaboration in this regard will not be provided here.

At least some civilly-catastrophic events may be accompanied by an electromagnetic pulse. Such a pulse can permanently damage many electrical circuits. By one approach, if desired, this controlled access container can be arranged and configured to provide electromagnetic pulse protection to objects contained therein. This can comprise, for example, providing sufficient electrically conductive shielding about that inner space. Techniques in this regard are also well known in the art and again require no further explanation here.

By one approach, if desired, these controlled access containers can be configured and arranged to substantially conceal their function as a container. This can comprise, for example, configuring and arranging the controlled access container to appear to comprise (and in fact to serve as) a seat, a counter, a podium, a pedestal, a work of art, a plant-bearing container, a wall, a floor, a ceiling, a building load-bearing structural support, a sign, an aquarium, an elevator, a closet, a store front, a door, a mirrored window, a product display and so forth.

If desired, it would also be possible to use a vehicle as such a controlled access container. This can include both self-powered vehicles (such as cars, trucks, vans, boats, aircraft, and so forth) as well as non-powered vehicles (such as trailers, barges, and the like). In such a case, the vehicle can be parked in a publicly accessible location such as a street parking spot, a parking garage location, or the like.

Referring again to FIG. 1, this process 100 then provides for placing 103 at least one of the plurality of carriable containers within the at least one controlled access container. This can comprise, if desired, placing a plurality of such carriable containers into a single controlled access container. By one approach, this plurality of carriable containers can share a common space within the shared controlled access container. By another approach, this plurality of carriable containers can be segregated from one another within the shared controlled access container. Such segregation can be partial (as when the carriable containers are separated by simple partitions) or relatively complete (as when the carriable containers are each contained within separate closable containers).

As one illustrative example in this regard, and referring momentarily again to FIG. 6, a given controlled access container 601 can have a plurality of segregated inner containers that are each accessed via a corresponding cover 605. If desired, each such cover 605 can have a corresponding lock mechanism 606 to control access to the carriable container contained therein. One may also provide an indicator 607 to provide information regarding the contents of each inner container. This indicator 606 can comprise, for example, a window to permit visual inspection of the contents of the inner container, a signal light to provide corresponding status information (such as the presence or absence of a carriable container), or the like.

There are various ways by which such carriable containers can be placed in these controlled access containers. In many cases, this will vary with respect to the form factor of the carriable containers and/or the controlled access containers themselves. In many cases, for example, it may be appropriate to place the carriable containers within the controlled access container in a horizontally aligned manner. In other cases, as when the controlled access container comprises a wall, it may be appropriate to vertically place the carriable containers one atop the other in the controlled access container.

Referring again to FIG. 1, this process 100 then provides for preauthorizing 104 at least one specific authorized beneficiary to have catastrophic event-based access to at least one carriable container as is contained within at least one of the controlled access containers. This preauthorization comprises effecting such authorization prior to the triggering catastrophic event itself occurring. So configured, this process 100 provides a mechanism whereby the authorized beneficiary will have access to the emergency supplies contained within that carriable container when and if the triggering catastrophic event occurs.

By one approach, this step 104 can comprise, for example, receiving a full payment for the carriable container and its contents prior to the triggering catastrophic event having occurred. By another approach, this step 104 can comprise receiving only a partial payment for the carriable container and its contents prior to the triggering catastrophic event having occurred (with a remaining portion becoming due upon the authorized beneficiary actually accessing the carriable container). By yet another approach, this step 104 can comprise receiving an agreement that payment for the carriable container and its contents will become due (or automatically debited and paid) when and if the authorized beneficiary gains access to the carriable container as per these teachings.

By one approach, this step 104 can comprise accepting consideration-based private civil security subscriptions from subscribers with respect to providing civilly-catastrophic event-based access to the carriable container. By one approach, these subscriptions may be accepted by, for example, a for-profit business. By another approach a not-for-profit business (such as a membership-based entity) may be the appropriate entity to offer and accept such subscriptions.

As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extends past the death of a named subscription beneficiary and further allows for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights regarding access);

non-transferable rights of access (as may occur when the subscription, by its terms and conditions, prohibits transfer of the right of access from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

geographically-based rights of access (as where the authorized beneficiary has a right to access such provisions only within a specified geographic area such as a given city center, major metropolitan area, county, state or province, country, or the like); and/or

non-ownership-based rights of access (as may occur when the subscription, by its terms and conditions, establishes the aforementioned right of access via, for example, a lease, rental, or borrowing construct).

If desired, a plurality of differentiated subscription opportunities can be offered in this regard. This plurality of differentiated subscription opportunities can correspond, for example, to providing access to differing controlled access containers and/or carriable containers. As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing emergency supplies that are economically selected while another subscription might provide for emergency supplies that are more costly and in turn reflect, for example, a wider variety of choices with respect to content, ease of use, durability, and so forth. As another example, a less costly subscription can provide access to a more limited selection of controlled access containers while a more costly subscription might provide access to an expanded selection of controlled access containers.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions can relate, if desired, to providing access in the event of a civilly-catastrophic event. As used herein, “civilly-catastrophic event” will be understood to refer to an event that substantially and materially disrupts a society's local, regional, and/or national infrastructure and ability to provide ordinary civil services. A civilly-catastrophic event can be occasioned by any of a wide variety of natural and/or intentionally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of intentionally-caused disasters capable of initiating a civilly-catastrophic event include both unintended events caused by intentional behaviors and actions as well as acts of war, terrorism, madness, or the like. Examples of intentionally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

As noted above, the controlled access containers, though located in publicly accessible areas, are likely distributed here and there around, for example, an urban area. As also noted above, these controlled access containers may not, in fact, be obvious as their true function may be at least partially disguised. This, in turn, can render it more difficult for an authorized beneficiary to locate such a controlled access container during a time of need. Therefore, if desired, this step 104 of preauthorizing specific authorized beneficiaries can further comprise providing the authorized beneficiaries with instructions regarding how to locate one or more of the controlled access containers (and hence the carriable containers contained therein).

Such information can be provided in a variety of forms. By one approach, this information can comprise hardcopy text, maps, and so forth that identify the location of controlled access containers that are available to the authorized beneficiary. By another approach, this information can comprise electronically delivered information that is provided, for example, on a regular (or irregular) basis to a receiving platform used by the authorized beneficiary. Other possibilities also exist in this regard. For example, upon confirming a travel itinerary, an authorized beneficiary could receive by email a map for the target destination that shows the location of such assets.

As noted above, the controlled access containers (and, in some cases, the carriable containers as well) are locked. This step 104 of preauthorizing authorized beneficiaries can therefore also comprise, if desired, providing the authorized beneficiaries with a capability of unlocking the access controlled container and/or the carriable container(s). There are various ways to effect this purpose, of course. By one approach this can comprise providing the authorized beneficiary with one or more physical keys. By another approach this can comprise informing the authorized beneficiary (or allowing the authorized beneficiary to themselves select) an enterable code (such as a specific numeric or alphanumeric string). By yet another approach this can comprise receiving biometric information of choice from the authorizing beneficiary and then instructing the authorized beneficiary regarding correct presentation of the relevant biometric characteristic when seeking to gain corresponding access.

If desired, the container-opening capability provided to the authorized beneficiary may be one that comprises a one-time-only access key. So configured, the key will only be capable of opening a single one of the controlled access containers and/or carriable containers. This can serve, for example, to discourage or prevent a given authorized beneficiary from inappropriately exploiting the supply of emergency provisions during a time of need to the detriment of other authorized beneficiaries.

This process 100 will also optionally accommodate controlling access 105 to the plurality of carriable containers. As noted above, this can be accomplished, at least in part, by requiring the authorized beneficiary to, for example, submit a pre-arranged code (such as an alphanumeric sequence and/or biometric information as corresponds to the authorized beneficiary) when seeking present access to the carriable container. This can also be accomplished, if desired, by limiting access to emergency needs situations (such as, but not necessarily limited to, civilly-catastrophic events). For example, this can be based upon detecting reception of an enabling remote control signal from an authorizing entity. This can also comprise detecting a loss of an ordinarily expected signal and/or a loss of electric poser (wherein the loss of the signal/power may be reasonably equated with an emergency situation).

If desired, access to a controlled access container can also be predicated upon, in whole or in part, presentation of an acceptable form of identification. This might comprise, for example, requiring the authorized beneficiary to swipe a credit or debit card that has been issued in their own name or that has been issued, for example, by the entity that is supporting the provision of these resources. It would also be possible, of course, to provide one or more persons at or near the controlled access container to confirm the authorized beneficiary's right of access and to themselves control the opening of the controlled access container and the distribution of its contents.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 7, an illustrative approach to such a platform will now be provided.

In this illustrative example, the controlled access container can comprise, at least in part, a processor 701 that controls (or itself comprises), for example, an access enabler 702 of choice. The latter can essentially comprise any device, component, or software element that serves to enable the lock mechanism to receive and respond to the authorized beneficiary's access key. The processor 701 can operably couple, if desired, to a power detector 703 that itself detects when a supply of electric power as is otherwise ordinarily available becomes unavailable. In addition, or in lieu thereof, the processor 701 can operably couple to a receiver 704 and signal detector 705 that respond to specific enabling signals and/or to an absence of an otherwise ordinarily present heartbeat signal or the like.

Those skilled in the art will recognize and understand that such an apparatus may be comprised of a plurality of physically distinct elements as is suggested by the illustration shown in FIG. 7. It is also possible, however, to view this illustration as comprising a logical view, in which case one or more of these elements can be enabled and realized via a shared platform. It will also be understood that such a shared platform may comprise a wholly or at least partially programmable platform as are known in the art.

Referring again to FIG. 1, this process 100 will also optionally accommodate maintaining 106 the emergency supplies. This can comprise, for example, ensuring current usability of the emergency supplies by ensuring, for example, that freshness and/or expiration dates remain current. This might comprise, for example, replacing soon-to-expire batteries and medicines as well as food items that have a limited shelf life.

Such maintenance 106 can also optionally comprise making adjustments to the emergency supplies to reflect dynamically changing circumstances as occur over time. As one illustration, a new item may become available that is particularly useful in dealing with or otherwise surmounting some condition that may likely arise upon the occurrence of a particular kind of catastrophic event. In such a case, maintaining such supplies can readily accommodate updating the acquired and stored items to include a supply of this new item.

Such maintenance 106 can also comprise maintaining the seasonal relevance of the emergency supplies. For example, severe weather phenomena such as hurricanes and tornadoes tend to occur only during certain times of the year and it may not be appropriate to maintain a year-long available supply of emergency provisions that anticipate such events. This step of maintaining 106 the emergency supplies can also comprise, of course, adding additional emergency supply items to already fielded carriable containers as appropriate.

Accordingly, such maintenance can readily comprise one or more of removing a particular one of the emergency supplies (as when a better substitute becomes available, when the item itself is shown to be less effective for its intended purpose than was originally thought, and so forth), adding additional ones of a particular item (as when it becomes subsequently understood that more of a particular item is desirable to achieve a particular goal or purpose), adding at least one new stored item that is not already stored, and so forth.

As alluded to above, a triggering catastrophic event can occur at any time of day and possibly without warning. As noted, a given authorized beneficiary may be away from home and work when such an event occurs. In such a case, it is possible that the authorized beneficiary will have other items with them that do not comprise an asset with respect to the authorized beneficiary's immediate needs but that the authorized beneficiary nevertheless does not wish to lose. Examples might include briefcases, laptop computers, umbrellas, files and reports, work-related clothing, books, backpacks, and so forth. Referring again to FIG. 1, this process 100 will therefore also optionally accommodate permitting 107 the authorized beneficiary to place an object in the controlled access container after gaining access to the carriable container. The authorized beneficiary can then close and re-lock the controlled access container to thereby better assure the safekeeping of the stored object.

This, in turn, can free the authorized beneficiary from needing to carry the object in question during the catastrophic event or while otherwise seeking to attend to their own safekeeping while nevertheless tending to improve the chances that the object will remain safe and available for future use. In such a case, this process 100 can also comprise returning 108 the stored object to the authorized beneficiary when appropriate. To illustrate, when the authorized beneficiary uses a unique key to gain access to the controlled access container, a correlation can be drawn between that unique key and the object that is now stored in the controlled access container. That same unique key could then later serve to confirm the authorized beneficiary's right to reclaim possession of that object.

It will be appreciated that these teachings provide for a highly flexible yet powerfully effective way by which a modern citizen can greatly improve their likelihood of receiving necessary or helpful emergency supplies following a catastrophic event. These teachings are sufficiently flexible so as to accommodate the needs and desires of a wide-ranging set of potential beneficiaries and a wide variety of challenging circumstances.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, each of the carriable containers could be provided with a proximity detector that is configured and arranged to detect the proximity of another one of the carriable containers. By this mechanism authorized beneficiaries would be able to more readily identify one another in an emergency scenario. As another example in this regard, training can be offered to the authorized beneficiary as a part of pre-authorizing the authorized beneficiary to have access to a carriable container. Such training can provide information, for example, regarding the contents of the carriable container, how to use those contents, and other information regarding emergency survival tips.

I claim:

1. A method comprising:
providing a plurality of carriable containers having emergency supplies contained therein wherein each of the plurality of carriable containers is readily carriable by an average adult human;
providing, at at least one publicly accessible location, at least one controlled access container;
placing at least one of the plurality of carriable containers within the at least one controlled access container;
prior to a triggering catastrophic event, preauthorizing at least one specific authorized beneficiary to have catastrophic event-based access to the at least one of the plurality of carriable containers within the at least one controlled access container;
such that the authorized beneficiary will have access to the emergency supplies contained within the carriable container when the triggering catastrophic event occurs.

2. The method of claim 1 wherein the emergency supplies comprise, at least in part, at least one of:
nourishment;
hydrating fluid;
foul weather clothing;
hazmat clothing;
breathing filters;
portable lighting;
eye protection;
medical supplies;
potassium iodide;
an ionizing radiation detector;
an ionizing radiation measurer;
rope;
a wearable harness;
fire starter;
a tool;
a weapon;
a noisemaker;
navigation equipment;
evacuation route information;
a wireless communicator;
an inflatable raft;
temporary shelter.

3. The method of claim 1 wherein the emergency supplies comprise, at least in part, disguise supplies such that the authorized beneficiary can significantly alter their appearance and thereby draw less third party interest to themselves.

4. The method of claim 1 wherein at least one of the plurality of carriable containers comprises at least one of:
a backpack;
a fanny pack;
a duffel bag;
a briefcase;
a diaper bag;
a shopping bag;
a purse;
a shoulder bag;
a trash container;
a physician's bag;
a suitcase.

5. The method of claim 1 wherein at least one of the plurality of carriable containers is configured and arranged to attach to the authorized beneficiary and further comprises external lighting such that a rescue service can more readily identify and locate the authorized beneficiary.

6. The method of claim 1 wherein at least one of the plurality of carriable containers comprises a locked carriable container.

7. The method of claim 6 wherein preauthorizing at least one specific authorized beneficiary further comprises providing the at least one specific authorized beneficiary with a capability of unlocking the locked carriable container.

8. The method of claim 7 wherein providing the at least one specific authorized beneficiary with a capability of unlocking the locked carriable container comprises providing the at least one specific authorized beneficiary with at least one of:
a physical key;
an enterable code;
instructions regarding presentation of at least one biometric characteristic of the at least one specific authorized beneficiary.

9. The method of claim 1 wherein at least one of the plurality of carriable containers comprises a carriable container having wheels such that the carriable container is readily rolled on the wheels to facilitate its movement.

10. The method of claim 1 wherein providing, at at least one publicly accessible location, at least one controlled access container comprises providing at least one controlled access container at each of a plurality of different publicly accessible locations.

11. The method of claim 10 wherein providing at least one controlled access container at each of a plurality of different publicly accessible locations comprises configuring and arranging at least some of the controlled access containers to conceal their function as a container of at least one of the plurality of carriable containers.

12. The method of claim 11 wherein configuring and arranging at least some of the controlled access containers to conceal their function as a container of at least one of the plurality of carriable containers comprises at least one of configuring and arranging at least one of the controlled access containers to appear to comprise:
a seat;
a counter;
a podium;
a pedestal;
a work of art;
a plant-bearing container;
a wall;
a floor;
a ceiling;
a building load-bearing structural support;
a sign;
an aquarium;
an elevator;
a closet;
a store front;
a door;
a mirrored window;
a product display.

13. The method of claim 10 wherein preauthorizing at least one specific authorized beneficiary to have catastrophic event-based access to the at least one of the plurality of carriable containers within the at least one controlled access container comprises, at least in part, providing the at least one specific authorized beneficiary with instructions regarding how to locate at least one of the plurality of carriable containers.

14. The method of claim 13 wherein providing the at least one specific authorized beneficiary with instructions regarding how to locate at least one of the plurality of carriable containers further comprises providing the at least one specific authorized beneficiary with instructions regarding how to locate a plurality of the plurality of carriable containers.

15. The method of claim 1 wherein placing at least one of the plurality of carriable containers within the at least one controlled access container comprises placing a plurality of the plurality of carriable containers within the at least one controlled access container.

16. The method of claim 1 wherein the at least one controlled access container comprises a vehicle.

17. The method of claim 16 wherein the vehicle comprises at least one of:
a self-powered vehicle;
a non-powered vehicle.

18. The method of claim 1 wherein preauthorizing at least one specific authorized beneficiary to have catastrophic event-based access to the at least one of the plurality of carriable containers within the at least one controlled access container further comprises accepting consideration-based private civil security subscriptions from subscribers with respect to providing civilly-catastrophic event-based access to the carriable container.

19. The method of claim 18 wherein accepting consideration-based private civil security subscriptions from subscribers comprises accepting the consideration-based private civil security subscriptions at a for-profit business.

20. The method of claim 18 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
non-ownership-based rights of access;
geographically-limited rights of access.

21. The method of claim 18 wherein the civilly-catastrophic event comprises at least one of:
a natural disaster;
an intentionally-caused disaster.

22. The method of claim 21 wherein the natural disaster comprises at least one of:
a severe weather event;
a severe geophysical event;
a large object impacting the Earth.

23. The method of claim 21 wherein the intentionally-caused disaster comprises at least one of:
warfare;
an act of terrorism;
an accident that results in public dispersal of a severe environmentally borne danger.

24. The method of claim 1 wherein providing a plurality of carriable containers having emergency supplies contained therein comprises providing at least some carriable containers having emergency supplies selected and appropriate for use with respect to a first emergency scenario and at least some carriable containers having emergency supplies selected and appropriate for use with respect to a second emergency scenario, wherein the first and second emergency scenarios are different from one another.

25. The method of claim 24 wherein at least some of the carriable containers bare an externally visible indication regarding a kind of emergency scenario for which the emergency supplies contained therein have been selected.

26. The method of claim 25 wherein the visible indication comprises a color-based code.

27. The method of claim 1 wherein providing a controlled access container comprises providing a controlled access container that is arranged and configured to provide electromagnetic pulse protection to the carriable container contained therein.

28. The method of claim 1 further comprising:
maintaining the emergency supplies.

29. The method of claim 28 wherein maintaining the emergency supplies comprises, at least in part, ensuring current usability of the emergency supplies.

30. The method of claim 28 wherein maintaining the emergency supplies comprises, at least in part, maintaining seasonal relevance of the emergency supplies.

31. The method of claim 28 wherein maintaining the emergency supplies comprises, at least in part, adding another emergency supply item to an already fielded carriable container.

32. The method of claim 1 further comprising:
controlling access to the plurality of carriable containers.

33. The method of claim 32 wherein controlling access to the plurality of carriable containers comprises, at least in part, requiring submission of a pre-arranged code from the authorized beneficiary when the authorized beneficiary seeks present access to the carriable container.

34. The method of claim 33 wherein the pre-arranged code comprises, at least in part, an alphanumeric sequence.

35. The method of claim 33 wherein the pre-arranged code comprises, at least in part, biometric information as corresponds to the authorized beneficiary.

36. The method of claim 32 wherein controlling access to the plurality of carriable containers comprises, at least in part, limiting access to emergency needs situations.

37. The method of claim 36 wherein the emergency needs situations comprise civilly-catastrophic events.

38. The method of claim 36 wherein limiting access to emergency needs situations further comprises, at least in part, detecting reception of an enabling remote control signal from an authorizing entity.

39. The method of claim 36 wherein limiting access to emergency needs situations further comprises, at least in part, detecting a loss of a signal.

40. The method of claim 36 wherein limiting access to emergency needs situations further comprises, at least in part, detecting a loss of electric power.

41. The method of claim 1 wherein providing a plurality of carriable containers having emergency supplies contained therein further comprises providing a plurality of carriable containers that each further comprises a proximity detector that is configured and arranged to detect proximity of another one of the carriable containers, such that one of the authorized beneficiaries can more readily identify another of the authorized beneficiaries in an emergency scenario.

42. The method of claim 1 wherein placing at least one of the plurality of carriable containers within the at least one controlled access container comprises vertically placing a plurality of the carriable containers one atop the other in the controlled access container.

43. The method of claim 1 wherein preauthorizing at least one specific authorized beneficiary to have catastrophic event-based access to the at least one of the plurality of carriable containers within the at least one controlled access container comprises one of:
receiving a full payment for the carriable container;
receiving a partial payment for the carriable container;
receiving an agreement that payment for the carriable container will become due when the authorized beneficiary gains access to the carriable container.

44. The method of claim 1 further comprising:
permitting the authorized beneficiary to place an object in the controlled access container after gaining access to the carriable container, such that the authorized beneficiary need not carry the object during a catastrophic event.

45. The method of claim 44 further comprising:
returning the object to the authorized beneficiary.

46. The method of claim 1 wherein preauthorizing at least one specific authorized beneficiary to have catastrophic event-based access to the at least one of the plurality of carriable containers within the at least one controlled access container further comprises providing the at least one specific authorized beneficiary with a one-time-only access key that is only capable of opening a single one of the plurality of carriable containers.
